(19) United States
(12) Patent Application Publication
(10) Pub. No.: US 2020/0329320 A1
(43) Pub. Date: Oct. 15, 2020

(54) HEARING DEVICE AND METHOD FOR OPERATING SUCH A HEARING DEVICE

(71) Applicant: SIVANTOS PTE. LTD., Singapur (SG)

(72) Inventor: KUNIBERT HUSUNG, ERLANGEN (DE)

(21) Appl. No.: 16/840,499

(22) Filed: Apr. 6, 2020

(30) Foreign Application Priority Data
Apr. 9, 2019 (DE) 102019205040

(51) Int. Cl. H04R 25/00; G06F 3/01

(52) U.S. Cl. CPC H04R 25/558; G06F 3/017

(57) ABSTRACT

A hearing device, in particular a hearing aid, has a radar sensor arrangement which has at least two radar sensors. The two radar sensors are used for capturing an operating gesture. The function of the hearing device is then changed in response to the type of operating gesture which was captured.

### CROSS-REFERENCE TO RELATED APPLICATION

This application claims the priority, under 35 U.S.C. § 119, of German application DE 10 2019 205 040, filed Apr. 9, 2019; the prior application is herewith incorporated by reference in its entirety.

### BACKGROUND OF THE INVENTION

### Field of the Invention

The invention relates to a hearing device, in particular a hearing aid. The invention also relates to a method for operating such a hearing device.

Persons who suffer from a reduction in their hearing often use a hearing aid. In this case, ambient sound is usually captured using an electromechanical sound transducer. The captured electrical signals are processed by an amplifier circuit and are introduced into the person's auditory canal by a further electromechanical transducer. Different types of hearing aids are known. The so-called “behind-the-ear devices” are worn between the skull and the pinna. In this case, the amplified sound signal is introduced into the auditory canal by a sound tube. A further common configuration of a hearing aid is an “in-the-ear device” in which the hearing aid itself is inserted into the auditory canal. The auditory canal is consequently at least partially closed by means of this hearing aid, with the result that, apart from the sound signals generated by the hearing aid, no further sound—or only a greatly reduced amount of sound—can enter the auditory canal.

In order to operate the hearing device, the hearing aid itself has operating elements such as buttons, rotary controllers or the like, for example. A user can change a function of the hearing aid with the aid of the operating elements. For example, it is possible for the user to choose between different operating modes, for example a normal operating mode, a flight mode or the like, or different operating programs or to set a volume by pressing a button or turning the rotary controller.

If the hearing aid is used as intended, that is to say if the user wears the hearing aid on or in the ear, the conventional operating elements are usually outside the field of view of the user. The operation of the hearing aid, for example the pressing of the button, must therefore be carried out “blind”. Such operation is not very intuitive. Furthermore, the contact-based operation of a hearing aid worn on or in the ear by the user is sometimes perceived to be uncomfortable. A further disadvantage here is that the operation can be observed by further persons and can be identified as such. Discreet operation of the hearing aid is therefore not possible.

It is also known from the prior art to operate the hearing aid by an additional, separate device, such as a remote control or a mobile telephone equipped with appropriate application software. In this case, the operation of the hearing aid presupposes the carrying of the separate device in a disadvantageous manner. This is in turn associated with a restriction in the comfort for the user.

### BRIEF SUMMARY OF THE INVENTION

The invention is based on the object of specifying an improved hearing device and an improved method for operating such a hearing device, wherein operating comfort is advantageously increased.

With respect to the hearing device, this object is achieved by means of the features of the independent hearing device claim and, with respect to the method, by means of the features of the independent method claim. The respective subclaims relate to advantageous developments and configurations.

For example, the hearing device is an earphone or contains an earphone. However, the hearing device is particularly preferably a hearing aid. The hearing aid is used to assist a person suffering from a reduction in their hearing. This assistance is, in particular, a basic function of the hearing aid. In other words, the hearing aid is a medical device which is used to compensate for partial hearing loss, for example. The hearing aid is, for example, a “receiver-in-the-canal” hearing aid (RIC), an in-ear hearing aid such as an “in-the-ear” hearing aid, an “in-the-canal” hearing aid (ITC) or a “complete-in-canal” hearing aid (CIC), hearing spectacles, a pocket hearing aid, a bone-conduction hearing aid or an implant. The hearing aid is particularly preferably a “behind-the-ear” hearing aid which is worn behind a pinna.

The hearing device has a radar sensor arrangement. In this case, the radar sensor arrangement is suitable, in particular provided and configured, for capturing an operating gesture and has at least two radar sensors, that is to say two or more radar sensors. During operation, (electromagnetic) waves are emitted by each of the radar sensors and are suitably reflected and/or scattered at an object, for example a hand or at least a finger of the user. The reflected/scattered waves are captured by the radar sensors. For example, the distance between the object and the respective radar sensor is determined on the basis of the time of flight of the waves. In other words, the period between the emission and the reception of the electromagnetic waves is determined and the distance is determined taking into account the propagation speed of the electromagnetic waves. Alternatively, the distance is determined, for example, on the basis of a changed waveform. For example, a movement, and in particular a direction of movement, of a hand and/or of one or more fingers of the user can be inferred by determining a temporal change in the distance and will be captured as an operating gesture.

Since the radar sensor arrangement contains at least two radar sensors, the operating gesture is captured on the basis of (a plurality of) radar signals from different sources, namely the at least two radar sensors, and therefore with a comparatively reduced computing power, lower energy consumption and cost-effective hardware. Furthermore, a susceptibility to interference is reduced, in particular. It is also possible to capture different operating gestures in a comparatively simple manner.

The radar sensor arrangement contains, for example, a radar sensor array having a number of radar sensors, wherein the number of radar sensors is greater than or equal to two and, in particular, is equal to three or nine. The distances captured by each of the radar sensors, also referred to as a distance value, are evaluated in a combined manner, for example, that is to say the distance values from each radar sensor are used to capture the operating gesture.

The radar sensors are suitably operated at a frequency which is between 76 GHz and 81 GHz, for example, and is preferably 77 GHz. In other words, the frequency of the emitted electromagnetic waves is between 76 GHz and 81 GHz. Energy-efficient operation is therefore possible. For example, the respective electromagnetic waves created by the radar sensors have the same frequency or different frequencies among one another and/or over time. For example, the frequency varies with the time, and/or a different frequency is assigned to each of the radar sensors. Evaluation is therefore simplified. Alternatively, the frequency is constant and/or is the same in the different radar sensors, for example. Complexity is therefore reduced and common parts can be used.

During operation of the radar sensor arrangement, a spatial monitoring area, for example in the form of a lobe, is assigned to each of the radar sensors by virtue of the emitted waves. In this case, the monitoring areas of the radar sensors partially or completely overlap, for example. Alternatively, the monitoring areas are at a distance from one another. The sum of the monitoring areas forms a spatial area which is monitored for the operating gesture. If the hearing device is used as intended, that is to say if a user wears the hearing device on or in the ear, for example, the monitored spatial area is formed, in particular, beside the user's head and extends, for example, as seen from the user's head, to a distance of up to 40 cm, suitably up to 30 cm or, in particular, up to 20 cm.

The operating gesture is, for example, a hand and/or finger gesture. In one configuration, the operating gesture is a circling movement of a hand or of a finger, a stroking of the thumb over the index finger or a relative movement of the thumb and index finger toward one another or away from one another. The operating gesture is, in particular, a two-dimensional or three-dimensional movement pattern. If the hearing device is used as intended, such an operating gesture can be carried out intuitively and simply by means of a corresponding hand and/or finger movement in the monitored spatial area, that is to say beside the user's head, for example. With an increasing number of radar sensors, the volume of the monitored spatial area increases, for example, thus further increasing user comfort. Furthermore, more complex and/or a higher number of different operating gestures can be captured with an increasing number of radar sensors.

In one configuration of the invention, each radar sensor contains at least one radar antenna, in particular a patch antenna. For example, the radar sensors have only one radar antenna or further radar antennas. The respective radar antenna is respectively used, in particular, both to transmit and to receive electromagnetic waves. Alternatively, the respective radar sensor respectively has a different radar antenna for transmission and reception.

In one configuration of the invention, the radar sensor arrangement contains a control arrangement. The control arrangement is provided and configured to operate the radar sensor arrangement. In other words, the control arrangement is preferably provided and configured to apply signals to the radar sensor arrangement, in particular the radar antenna(s) of the radar sensors, in such a manner that electromagnetic waves are generated. The control arrangement is preferably also used to read signals captured by the radar sensor arrangement and to further process and/or evaluate them, in particular with regard to the capture of the operating gesture. In other words, an evaluation arrangement is preferably formed by means of the control arrangement. For example, the control arrangement contains an application-specific circuit (ASIC) or a microprocessor which is programmable, for example.

The control arrangement forms, for example, a common structural unit with an electronic arrangement, which provides, for example, the basic function of the hearing device described further above, that is to say, for example, the capture of ambient sound, the processing of the latter and the forwarding thereof to the user's auditory canal. The control arrangement and the electronic arrangement are arranged in this case on a common circuit carrier, in particular a printed circuit board, for example. A compact and cost-effective hearing device is therefore pro-vided. Alternatively, the control arrangement is formed separately from the electronic arrangement, for example on a printed circuit board.

In one configuration of the invention, the control arrangement is provided and configured, during operation of the radar sensor arrangement, to operate, for example, each radar sensor continuously, that is to say, in particular, substantially without interruption or permanently. Alternatively or in combination, during operation, the radar signals captured by each of the radar sensors are preferably processed further/evaluated at the same time, in particular with regard to the capture of the operating gesture.

In one configuration of the invention which is preferred in this respect, the control arrangement comprises a multiplexer for selecting one of the radar sensors. The multiplexer is suitable, in particular provided and configured, for selecting one of the radar sensors, in particular for processing and evaluating the radar signals captured by the respective radar sensor. In other words, a radar sensor can be selected by the multiplexer and the radar signals captured using the selected radar sensor are then subjected to processing and evaluation with regard to the capture of the operating gesture.

The radar signals captured by the radar sensors are applied in this case, in particular as input signals, to an assigned input of the multiplexer in each case. One of the radar signals is respectively selected by the multiplexer, that is to say switched through to an output of the multiplexer. Since the operating gesture, that is to say, in particular, the movement of the user's hand and/or finger in the monitored spatial area, is carried out slowly in comparison with the switching frequency of the multiplexer, the operating gesture can be reliably captured. The provision of the multiplexer therefore enables particularly simple processing and evaluation since only the radar signals from one (single) radar sensor respectively preferably need to be processed and evaluated at one time. A required computing power and an energy requirement are therefore reduced. Energy-efficient and energy-saving operation of the hearing device is therefore enabled. The operation of choosing between the radar sensors can be carried out in this case in an alternating manner in terms of time, in particular sequentially or (pseudo-) randomly. For example, the changeover is periodic. In other words, the multiplexer is actuated periodically. In this case, the period is expediently less than 1 second and is between 0.001 second and 0.1 second, for example.

Alternatively or additionally, the multiplexer is provided and configured to select one of the radar sensors, to which a signal is applied in order to generate electromagnetic waves. In this case, the operation of choosing between the radar sensors is carried out, for example, in an alternating manner in terms of time, in particular sequentially or (pseudo-) randomly. Only a single radar sensor is therefore preferably operated at any time, which in turn contributes to energy-saving operation.

In a further configuration of the invention, an amplifier is connected downstream of the multiplexer. The amplifier is provided and configured to amplify the radar signal switched through from the respective radar sensor via the multiplexer. Since only the radar signal from a single radar sensor is switched through by the multiplexer at a time, only a single amplifier is required, in particular. Only a single amplifier is therefore preferably present. A required installation space and an energy requirement are therefore reduced. Production costs are also reduced.

An analog/digital converter is preferably connected downstream of the amplifier. The analog/digital converter is provided and configured to convert an analog out-put signal from the multiplexer, namely one of the analog radar signals, into a digital output signal (word), namely a corresponding digital radar signal. During operation, the output signal is expediently evaluated with regard to the capture of the operating gesture.

According to a further configuration of the invention, the analog/digital converter comprises a demultiplexer which is preferably provided and configured to switch through a signal applied to its input to one of a plurality of outputs.

In one preferred configuration of the invention, a clock generator is provided and is used to apply signals to the multiplexer and the demultiplexer. The clock generator is an oscillator, for example. The clock generator is preferably provided and configured to operate the multiplexer and the demultiplexer at the same clock rate and to apply the same clock signal to them. For example, the demultiplexer is provided and configured to switch through a radar signal, which is captured by one of the radar sensors and is conducted via the multiplexer, the possible amplifier and the analog/digital converter, from its input to a single common output, wherein the radar signal which is now digital is preferably provided with an identifier. In this case, the identifier corresponds, in particular, to the current input of the multiplexer. The identifier therefore allows a unique assignment of the radar signal applied to the output of the demultiplexer to the respective radar sensor which was originally used to capture the radar signal. In summary, the clock generator enables, in particular, synchronous operation of the multiplexer and of the demultiplexer as well as simple and energy-efficient evaluation of the radar signals captured by the radar sensors.

The hearing device preferably contains a housing. The housing is produced from plastic, for example, and delimits an interior formed inside the housing from an external environment by a number of housing walls. For this purpose, the housing contains, for example, a first trough-shaped part and a cover closing the first part. The possible electronic arrangement providing the basic function of the hearing device and the control arrangement of the radar sensor arrangement are accommodated in the interior, for example. The housing has a visible side. In particular, the cover contains the visible side. The visible side faces away from the interior of the housing and can be seen, at least in sections, from the external environment with the naked eye. The visible side is preferably formed by a housing wall of the housing, which housing wall faces away from the user's head if the hearing device is used as intended, that is to say if the user wears the hearing device on or in the ear. The visible side therefore faces, for example, the spatial area monitored for an operating gesture by the radar sensor arrangement.

The radar sensors are integrated, for example, in the housing wall assigned to the visible side and are accommodated, for example, in a corresponding recess in the housing wall in each case. The electromagnetic waves from the radar sensors can therefore be directly emitted into the monitored spatial area without having to first of all penetrate a housing wall. The radar sensors preferably terminate flush with the visible side, thus forming a smooth and haptically pleasant surface on the visible side. An accumulation of foreign particles is also prevented. Alternatively, the radar sensors are arranged, for example, in the interior of the housing below the visible side, in which case the radar sensors then emit the electromagnetic waves during operation into the monitored spatial area through the housing wall assigned to the visible side, in particular the cover. A visible appearance of the hearing device is therefore not changed.

In order to provide at least the untrained user, in particular when handling the radar sensor arrangement, with assistance as regards the position of the radar sensors and therefore the monitored spatial area, the radar sensors are optically highlighted on the visible side, for example by a colored marking. In particular, a marking representing the contours of the radar sensors is present on the visible side.

The method is used to operate a hearing device having a radar sensor arrangement which has at least two radar sensors and is intended to capture an operating gesture. The method provides for an operating gesture to be captured by means of the radar sensors and for a function of the hearing device to then be changed. Operating comfort is therefore increased.

The function of the hearing device may be any hearing device function. For example, the function is the adjustment of a volume, the selection of an operating mode or operating program and the switching-off of the hearing device (“power-off”). The function preferably contains at least one of the above-mentioned configurations.

The operating gesture is captured, for example, by means of the possible control arrangement which is used to evaluate the radar signals (radar sensor signal) captured by the radar sensors, in particular the temporal profiles of said radar signals. For this purpose, the control arrangement comprises, in particular, a microcontroller with a control program which is implemented thereon and contains an evaluation algorithm, in particular. For example, one or more signal profiles representing operating gestures are stored in a memory, wherein these signal profiles are compared with radar signal profiles captured by the radar sensors. If the captured radar signal profiles correspond to the stored signal profiles or at least one of the stored signal profiles within a permissible tolerance deviation, the operating gesture is expediently considered to be captured. Statistical methods and/or artificial intelligence, for example, can be used for the evaluation.

In one configuration of the method, different functions of the hearing device are assigned to different operating gestures. For example, a first operating gesture is used to change a first function of the hearing device, while a second operating gesture is used to change a second function of the hearing device. The first operating gesture is, for example, a hand movement and the second operating gesture is, for example, a relative movement of two fingers or of a finger and the thumb.

In one preferred configuration of the method, the radar sensor arrangement changes, in response to a trigger signal, from an idle mode, in which the radar sensors are not operated to capture the operating gesture, to an active mode, in which the radar sensors are operated to capture the operating gesture. For example, an energy consumption of the radar sensor arrangement is close to or equal to zero in the idle mode, but is at least greatly reduced in comparison with the active mode. Energy-saving operation of the hearing device is therefore enabled.

For example, the radar sensor arrangement changes to the active mode if there is a sufficient probability of the user wishing to change a function of the hearing device by the operating gesture. The trigger signal may be, for example, the switching-on of the hearing device (that is to say a change from “power-off” to “power-on”). After the hearing device has been switched on, the radar sensor arrangement is preferably operated in the active mode for a predetermined period, for example 5 minutes, 10 minutes or 20 minutes. After expiry of the predetermined period, the radar sensor arrangement changes to the idle mode. The radar sensor arrangement changes from the idle mode to the active mode in response to the trigger signal, for example if a predetermined hearing situation or a predetermined change in the hearing situation, in particular an ambient volume, is detected, and expediently remains in the active mode for the predetermined period again.

The developments and advantages explained in connection with the hearing de-vice can be analogously also applied to the method for operating a hearing device and vice versa.

Exemplary embodiments of the invention are explained in more detail below on the basis of a drawing, in which:

Other features which are considered as characteristic for the invention are set forth in the appended claims.

Although the invention is illustrated and described herein as embodied in a hearing device and a method for operating such a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration schematically showing a hearing device according to the invention;

FIG. 2 is an illustration schematically shows a visible side of the hearing device having a radar sensor arrangement having a radar sensor array;

FIG. 3 is a block diagram showing a first exemplary embodiment of the radar sensor array;

FIG. 4 is a block diagram showing a second exemplary embodiment of the radar sensor array;

FIG. 5 is a block diagram showing a third exemplary embodiment of the radar sensor array;

FIG. 6 is a block diagram showing a schematic circuit representation of the radar sensor arrangement;

FIG. 7 is a flow diagram showing a method for operating the hearing device; and

FIG. 8 is a graph showing a temporal profile of radar signals.

### DETAILED DESCRIPTION OF THE INVENTION

Mutually corresponding parts are provided with the same reference signs in all figures.

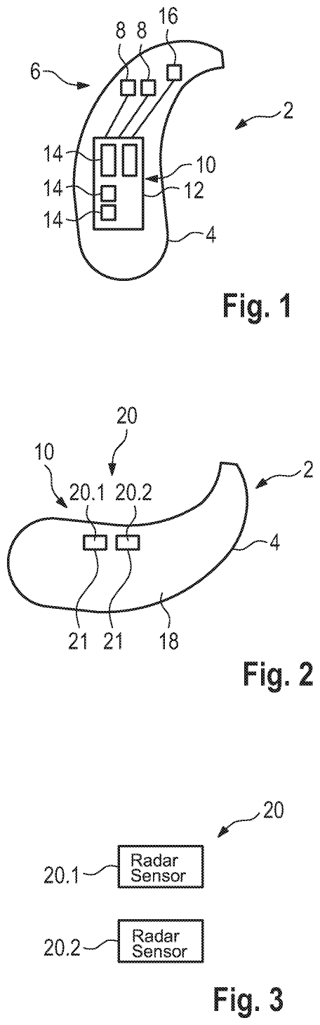

Referring now to the figures of the drawings in detail and first, particularly to FIG. 1 thereof, there is shown a schematic view of a hearing device in the form of a hearing aid 2 which is provided and configured to be worn behind a user's ear. The hearing aid 2 has a sound tube which is not illustrated and, if the hearing aid 2 is used as intended, is inserted into the user's ear. The hearing aid 2 contains a housing 4 which is produced from a plastic. A microphone 6 having two electromechanical sound transducers 8, for example, is arranged inside an interior formed by the housing 4. The two electromechanical sound transducers 8 make it possible to change a directional characteristic of the microphone 6 by changing a temporal offset between the acoustic signals captured by the respective electro-mechanical sound transducer 8. The microphone 6 is therefore an arrangement of electromechanical sound transducers 8. Alternatively, a microphone arrangement having a plurality of microphones is used, for example. The two electromechanical sound transducers 8/microphones are coupled, by signal technology, to an electronic arrangement 10 which is used for signal processing and contains an amplifier circuit, for example.

The electronic arrangement 10 is at least partially formed by circuit elements 14 arranged on a first side of a printed circuit board 12, for example electrical and/or electronic components. A loudspeaker 16 is also coupled to the electronic arrangement 10 using signal technology and is used to output the audio signals, which are recorded using the micrcphone 6 and/or are processed using the electronic arrangement 10, as sound signals. These sound signals are conducted into the ear of the user of the hearing aid 2 by the sound tube which is not illustrated in any more detail.

If the hearing aid 2 is used as intended, that is to say if the user wears the hearing aid 2 behind the ear, a first side of the housing 4 faces the user's head and a second side opposite the first side faces away from the head and is therefore visible, at least in sections, to the naked eye. This second side is shown in FIG. 2 and is referred to as the visible side 18 below.

The hearing aid 2 also contains a radar sensor arrangement 20. The radar sensor arrangement 20 is suitable for capturing an operating gesture B (FIG. 3) and contains a radar sensor array having two radar sensors 20.1 and 20.2. The radar sensors 20.1, 20.2 are integrated in the visible side 18 of the housing 4. The radar sensors 20.1, 20.2 are optically also contrasted from the visible side using color. The user is therefore provided with an indication of the presence and the position of the radar sensors 20.1, 20.2. In the interior formed by the housing 4, the radar sensors 20.1, 20.2 are arranged on the printed circuit board 12, to be precise on a second side of the printed circuit board 12 which is opposite the first side of the printed circuit board 12.

Each radar sensor 20.1, 20.2 contains a radar antenna 21 in the form of a patch antenna. In this case, the patch antenna is formed in a two-dimensional manner on the printed circuit board 12 and has an extent in an area which is parallel to the main direction of extent of the printed circuit board 12. In particular, the patch antennas are at least partially formed by means of conductor tracks on the printed circuit board 12. As is also clear from FIG. 2, the radar sensors 20.1, 20.2 are arranged in an edge area of the visible surface 18. In this case, if the hearing aid 2 is used as intended, the edge area is not covered by the user's head or ear. In other words, the radar sensors 20.1, 20.2b are therefore uncovered in a direction facing away from the head.

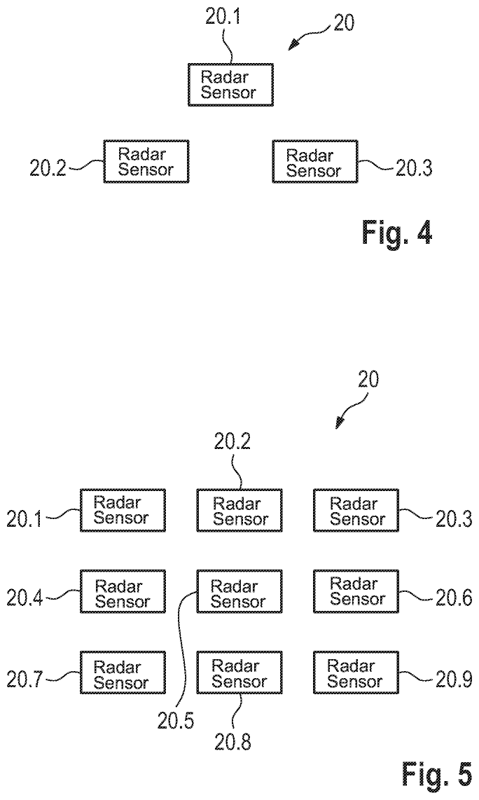

FIG. 4 shows a further variant of the radar sensor array. The radar sensor array contains only the two radar sensors 20.1, 20.2. The radar sensors 20.1, 20.2 have a substantially rectangular shape. In the direction of their longitudinal extent, the radar sensors 20.1, 20.2 are at a distance from one another and are arranged parallel to one another. In a direction transverse to the longitudinal extent, the radar sensors 20.1, 20.2 are arranged in a manner aligned with one another.

FIG. 5 shows a further variant of the radar sensor array which has three substantially rectangular radar sensors 20.1, 20.2, 20.3. Like in the preceding exemplary embodiments as well, the radar sensors 20.1, 20.2, 20.3 are structurally identical to one another and are arranged to form an isosceles triangle.

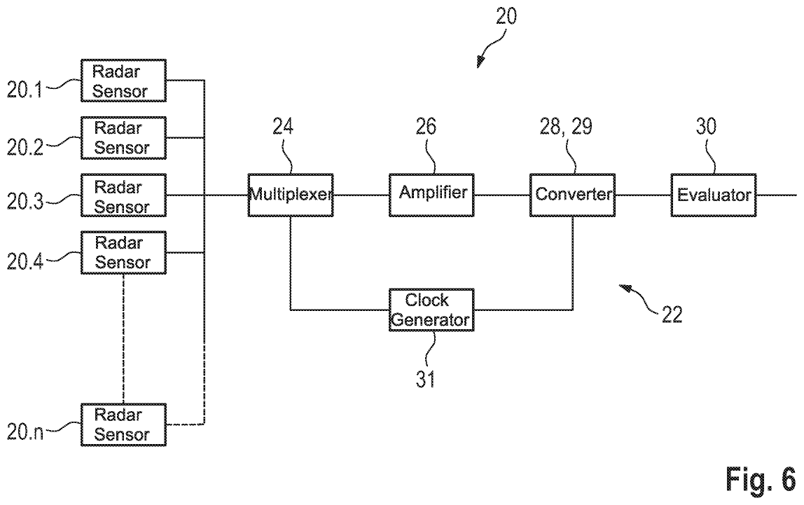

FIG. 6 shows a further alternative of the radar sensor array. The radar sensor array has nine radar sensors 20.1 to 20.9 which are substantially rectangular and are structurally identical to one another. The radar sensors 20.1 to 20.9 are arranged in a matrix having three columns and three rows.

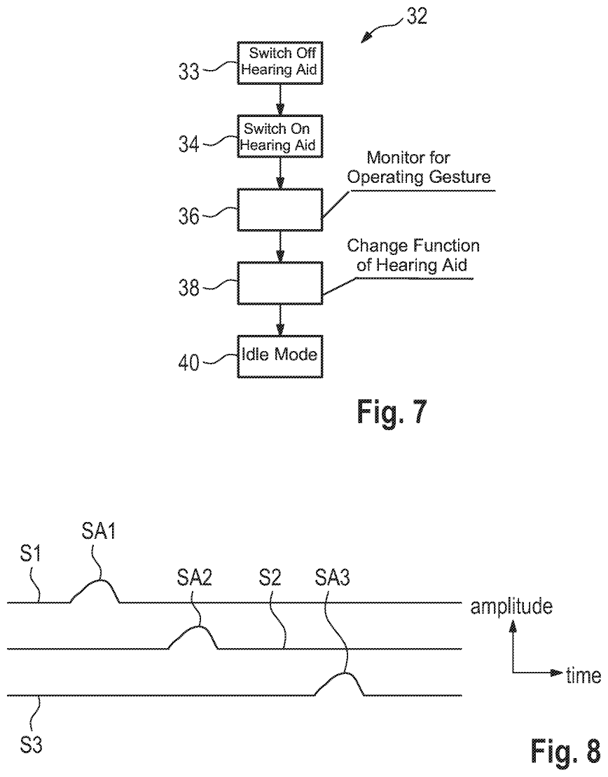

FIG. 7 illustrates a schematic circuit representation of a radar sensor arrangement 20 according to the invention. The radar sensor arrangement 20 has the radar sensors 20.1 to 20.n and a control arrangement 22. Each of the radar sensors 20.1 to 20.n is connected to a respectively assigned input of a multiplexer 24. For the sake of clarity, only one input of the multiplexer 24 is shown in FIG. 4. On the output side, an amplifier 26 is connected downstream of the multiplexer 24. In other words, the output of the multiplexer 24 is connected to the input of the amplifier 26 using signal technology. The amplifier 26 is an analog amplifier.

On the output side, an analog/digital converter 28 is connected downstream of the amplifier 26, that is to say an output of the amplifier 26 is connected to the input of the analog/digital converter 28 using signal technology. The analog/digital converter 28 contains a demultiplexer 29. An evaluation arrangement 30 is connected downstream of the analog/digital converter 28. In other words, a signal output of the analog/digital converter 28 is connected to an input of the evaluation arrangement 30 using signal technology. The evaluation arrangement 30 is used to evaluate the captured signals with respect to the capture of the operating gesture B. The control arrangement 22 also contains a clock generator 31 which is connected to the multiplexer 24 and to the analog/digital converter 28 containing the demultiplexer 29 using signal technology. In this case, the multiplexer 24 and the demultiplexer 29 are controlled in a synchronous manner by the clock generator 31.

FIG. 5 shows a method 32 for operating the hearing aid 2. In a first work step 33, the hearing aid 2 is in a switched-off state (“power-off”) in which no ambient signals are captured by the microphone 6, processed and output via the loudspeaker 16. In other words, in the switched-off state, the hearing aid 2 is not used as intended and is not worn by the user behind the ear, for example. In this case, the radar sensor arrangement 20 is in an idle mode in which the radar sensors 20.1 to 20.n are not operated to capture the operating gesture B. The operating gesture B is therefore not captured in the idle mode.

In a second work step 34, the hearing aid 2 is changed from the switched-off state to a switched-on state (“power-on”) on the basis of a user input. In other words, the user switches on the hearing aid 2, for example by pressing a button on the hearing aid 2. The hearing aid 2 is therefore fundamentally available for use as intended. A trigger signal is generated during the change from the switched-off state to the switched-on state. At the same time, a timer with a period of 10 minutes is started. In response to the trigger signal, the radar sensor arrangement 20 changes from the idle mode to an active mode in which the radar sensors 20.1 to 20.n are operated to capture the operating gesture B. In this case, electromagnetic waves are emitted by each of the radar sensors 20.1 to 20.n.

With each clock signal from the clock generator 31, one of the radar sensors 20 is selected by the multiplexer 24. The radar signal from the selected radar sensor 20 is conducted to the amplifier 26 and is therefore amplified by means of the latter. The amplified radar signal is then supplied to the A/D converter 28 and to the demultiplexer 29 and is therefore converted into a digital word which has the identifier of the selected radar sensor 20.

This digital word, that is to say the digital radar signal, is monitored for the operating gesture B or at least a part of the latter by means of the evaluation arrangement 30 in a third work step 36. With the subsequent clock signal from the clock generator 31, the subsequent radar sensor 20 is selected by the multiplexer 24. The demultiplexer 29 is also accordingly set further, with the result that the identifier of the newly selected radar sensor 20 is used during the conversion into the digital word. A monitoring area, for example in the form of a lobe, is there-fore formed by each of the radar sensors 20.1 to 20.n. Overall, a spatial area is therefore monitored for the operating gesture B by the radar sensor arrangement 20. If the user fits the hearing aid 2 behind his ear, the monitored spatial area is beside the user's head and, in particular, beside the user's ear. In this case, the monitored spatial area extends at a distance of approximately up to 30 cm beside the user's head.

FIG. 8 shows the temporal profile of a first radar signal S1, a second radar signal S2 and a third radar signal S3 which are checked by the evaluation arrangement 30, in which case the radar sensor arrangement 20 shown in FIG. 4 is used. In this case, the first radar signal S1 is assigned, by way of example, to the first radar sensor 20.1, the second radar signal S2 is assigned to the second radar sensor 20.2 and the third radar signal S3 is assigned to the third radar sensor 20.3. In this exemplary embodiment, the operating gesture B is defined by a circling movement of a finger of the user starting from the first radar sensor 20.1, via the second radar sensor 20.2, to the third radar sensor 20.3. In this case, the user's finger successively passes through the monitoring areas assigned to the radar sensors 20.1 to 20.3, as indicated by the arrows in FIG. 4. In this case, the electromagnetic waves emitted by the radar sensors 20.1 to 20.3 are reflected at the finger and are reflected to the radar sensors 20.1 to 20.3 and are captured there. On account of the movement of the finger, a signal response SA1, SA2, SA3 characteristic thereof appears in each radar signal S1, S2, S3, specifically when the finger definitely moves through the assigned monitoring area.

In this case, each signal response SA1, SA2, SA3 contains a rise in the respective radar signal S1, S2, S3, which is associated with the finger approaching the respective monitoring area, and a fall in the respective radar signal S1, S2, S3, which is associated with the finger subsequently moving from the respective monitoring area. The signal responses SA1, SA2, SA3 occur with a temporal offset with respect to one another in a manner corresponding to the movement of the finger through the monitoring areas. A check in order to determine whether the signal responses SA1, SA2, SA3 satisfy at least one predetermined criterion is carried out using the evaluation arrangement 30. For example, the captured radar signals S1, S2, S3 or the signal responses SA1, SA2, SA3 are compared with one or more signal profiles stored in a memory of the evaluation arrangement 30. If the captured radar signals S1, S2, S3 or the signal responses SA1, SA2, SA3 correspond to the stored signal profiles within a permissible tolerance deviation, the criterion is considered to have been satisfied. Alternatively or in combination, in particular, the amplitude, the gradient, the temporal offset of the signal responses SA1, SA2, SA3 with respect to one another and/or their respective value with respect to a respective assigned limit value is/are checked.

In the present example, the temporal offset is checked using the evaluation arrangement 30 and is compared with a specification. In this case, the temporal sequence and the temporal offset of the signal responses SA1, SA2, SA3 satisfy the predetermined criterion and the operating gesture B is considered to have been captured.

In a subsequent fourth work step 38, a function of the hearing aid 2 is then changed and the volume of the hearing aid 2, that is to say its gain factor, is increased, for example.

If the period of the timer, which was started in the second work step 34, has expired, a fifth work step 40 is carried out and the radar sensor arrangement 20 is changed to the idle mode again. It is therefore no longer possible to capture the operating gesture B using the radar sensor arrangement 20. An energy requirement is consequently reduced. If a particular external event occurs, for example a change in the acoustic environment, the radar sensor arrangement 20 is operated again and the respective radar signals are evaluated by means of the evaluation arrangement 30 and are monitored for the presence of the operating gesture B. In this case too, the radar sensor arrangement 20 is operated only for the determined period again.

The invention is not restricted to the exemplary embodiments described above. Rather, other variants of the invention can also be derived therefrom by a person skilled in the art without departing from the subject matter of the invention. In particular, all individual features described in connection with the individual exemplary embodiments can also be combined with one another in another manner without departing from the subject matter of the invention.

### LIST OF REFERENCE SIGNS

2 Hearing aid
4 Housing
6 Microphone
8 Sound transducer
10 Electronic arrangement
12 Printed circuit board
14 Circuit element
16 Loudspeaker
18 Visible side
20 Radar sensor arrangement
20.1 to 20n Radar sensor
21 Radar antenna
22 Control arrangement
24 Multiplexer
26 Amplifier
28 Analog/digital converter
29 Demultiplexer
30 Evaluation arrangement
31 Clock generator
32 Method for operating a hearing device
33 First work step
34 Second work step
36 Third work step
38 Fourth work step
40 Fifth work step
B Operating gesture
S1 First radar signal
S2 Second radar signal
S3 Third radar signal
SA1 First signal response
SA2 Second signal response
SA3 Third signal response

1. A hearing device, comprising:
a radar sensor configuration having at least two radar sensors for capturing an operating gesture.

2. The hearing device according to claim 1, wherein each of said radar sensors has at least one radar antenna.

3. The hearing device according to claim 1, wherein said radar sensor configuration has a controller with a multiplexer for selecting one of said radar sensors.

4. The hearing device according to claim 3, further comprising an amplifier connected downstream of said multiplexer.

5. The hearing device according to claim 4, further comprising an analog/digital converter connected downstream of said amplifier.

6. The hearing device according to claim 5, wherein said analog/digital converter has a demultiplexer.

7. The hearing device according to claim 6, further comprising a clock generator used to apply signals to said multiplexer and said demultiplexer.

8. The hearing device according to claim 1, further comprising a housing having a visible side and a housing wall, wherein said radar sensors are disposed in said housing wall, and/or wherein said radar sensors can be optically seen on the visible side.

9. The hearing device according to claim 1, wherein the hearing device is a hearing aid.

10. The hearing device according to claim 2, wherein said at least one radar antenna is a patch antenna.

11. The hearing device according to claim 8, wherein said radar sensors are disposed in said housing wall in a manner flush-mounted with the visible side.

12. A method for operating a hearing device having a radar sensor configuration with at least two radar sensors for capturing an operating gesture, which comprises the step of:
capturing the operating gesture by means of the radar sensors and a function of the hearing device is then changed.

13. The method according to claim 12, wherein the radar sensor configuration changes, in response to a trigger signal, from an idle mode, in which the radar sensors are not operated to capture the operating gesture, to an active mode, in which the radar sensors are operated to capture the operating gesture.
